(19) United States
(12) Patent Application Publication
(10) Pub. No.: US 2004/0236588 A1
(43) Pub. Date: Nov. 25, 2004

(54) System and method for licensing content on updatable storage media

(76) Inventors: Steve Millard, Swey Hills NSW (AU); Joseph Hayes, Frenchs Forest NSW (AU)

Correspondence Address: Carr & Ferrell, 2200 Geng Road, Palo Alto, CA, 94303, US

(21) Appl. No.: 10/469,623

(22) PCT Filed: Feb. 20, 2002
(86) PCT No.: PCT/AU02/00172

(30) Foreign Application Priority Data
Feb. 20, 2001 (AU) PR 3217

(51) Int. Cl. G06F 17/60

(52) U.S. Cl. 705/1

(57) ABSTRACT

A system and method for licensing content on an updated storage media is provided where new licensed content is downloaded and stored onto the updatable storage media containing licensing rights. The licensing rights are stored in a SMLD on the storage media. The rights will be authenticated by a rights management server somewhere on the Internet. If the rights management server determines that a user has rights to the new content, then the user is allowed to access and download the new content from a content server. The present invention may be utilized in various industries such as music, film, B2B, education, and television and may be embodied on various media such as DVD storage media, CD storage media, and hybrid optical disk media.

### CROSS-REFERENCES TO RELATED APPLICATIONS

This application claims the benefit of Australian Provisional Patent Application Serial No. PR3217, filed on Feb. 20, 2001, entitled “Method of Licensing Content on Updatable Digital Media,” which is incorporated herein by reference.

### BACKGROUND OF THE INVENTION

1. Field of the Invention

The present invention relates generally to optical disk formats, and more particularly to writable or re-writable optical disk formats containing licensed storage area reserved for recordable content.

2. Description of Related Art

Recently, distribution of content in the form of data, music, video, or other forms of information via collectable digital media has escalated in popularity. Collectable digital media include Compact Disk (CD), Digital Versatile Disk (DVD), minidisks, and memory sticks. Advantageously, these collectable media allow users to acquire content that is tailored to the user's specific interests. This interest may cover artworks supplied with the media and commentary supplied about data contained on the media such as track titles and artist photographs. As a further advantage, industries such as the music industry, are able to promote the collectable media (e.g., CD of an album) and use collectable images or content in a related promotional campaign.

This collectable mentality is fundamentally important to certain industries. For example, evolution of convergent technologies such as broadband Internet may be a threat to long-term existence of music and other similar industries (e.g., downloading and recording of music over the Internet poses a serious threat to sales of music CDs). The threat exists because the music industry relies primarily on manufacture, distribution, and sale of collectable media such as CDs and minidisks.

Writable disk media are readily available to users. This medium allows the user to create a digital clone of any optical disk, but does not give the user the collectable images and options that would normally be provided with the purchase of an original collectable media. The writable disk media also does not give users the right to infringe copyright or other legal rights in making the digital clone of the original collectable media. This is most prevalent in digital media as each copy is, itself, a master.

An exemplary writable disk is shown in FIG. 1, which illustrates an architectural block diagram of content of a conventional Enhanced CD (E-CD) format. The E-CD plays like standard audio CDs in audio players while also containing accompanying multimedia content which may be loaded into a compatible CD-ROM drive of a personal computer. The conventional E-CD contains a main menu section 100 which further comprises a play all selector 102, video selector 104, a web link selector 106, a biography selector 108, a photo selector 110, and an audio selector 112. Each of these selector units is coupled to their respective databases. Thus, the video selector 104 is coupled to a video gallery 114 which contains video clips 116, while the web link selector 106 is coupled to a web link database 118 containing web addresses. Similarly, a biography database 120 containing artist biographical information is connected to the biography selector 108 and photos stored in a photo gallery 122 are supplied to the photo selector 110. The E-CD further includes an audio track database 124 containing a plurality of audio tracks 126. Thus, the E-CD offers the user a cross platform capability that plays standard audio tracks on a CD player and multimedia data readable on a personal computer or other computing device. Those skilled in the art will recognize that varying selector units may be used in the E-CD.

Similarly, video media such as DVDs have gained in popularity. DVD players are becoming commonplace and are replacing video tape players (e.g., VHS players) as a preferred method of watching video content. Some skilled in the art consider it inevitable that DVD writable or rewritable disks will replace the complete functionality of the VHS tape. Subsequently, the issue of copyright protection will become prominent as content is recorded on this format.

FIG. 2 shows an exemplary block diagram of a conventional DVD architecture. As shown, a main menu section 200 comprises various active “buttons”. Some of these buttons, such as the play movie selector 202, chapter selector 204, and language selector 206, are related to the viewing of a movie contained on the DVD. The playall selector 202 is preferably coupled to a list of video chapters 208, while chapter selector 204 obtains video content from a video database 210 containing chapter videos 212. Further, the language selector 206 is coupled to a language database 214 containing various languages in which the movie may be displayed with and is further coupled to a subtitle database 216. For example, the movie may be viewed in English, French, or Spanish with or without subtitles. Although FIG. 2 shows selection of subtitles through the language selector 206, alternatively, a separate subtitle selector may be utilized in the main menu selection 200.

Playback of the movie may be further tailored to a user's preference by an audio playback selector 218 and a video playback selector 220. The audio playback selector 218 sets sound options for the movie. For example, if the DVD player is hooked up to a surround sound speaker system, then the audio playback selector 218 may be set to “stereo 5.1.” Other audio playback options may include stereo 2.1, Dolby Digital, etc. These various audio playback options are stored in an audio playback database 222. Similarly, the video playback selector 220 sets video display options such as normal or widescreen display. These display options are preferably stored in a video playback database 224.

Conventional DVDs typically contain additional multimedia content beyond just the movie such as artist biographies and photos. Thus, the DVD may also comprise an artist biography selector 226 coupled to a biography database 228 and a photo selector 230 coupled to a photo gallery 232. Other extra content can include director or actor interviews, footage cut from the film, or alternative endings to the movie. Typically, the DVDs further comprise a copyright protection message 234 and a corporate logo 236.

In some more recent DVDs, web links may be provided so that the user may link to websites of related interest to the DVD. For example, the movie on the DVD may have its own promotional website. In this example, the DVD must be played in a personal computing or similar device (e.g., personal computers, “WebTV”, etc.) connected to the Internet. A web link selector 238 enables the personal computing device to connect to the movie website address which is listed in a web link database 240.

Both the prior art CD and DVD contain historical content as the disk is manufactured as read only media. The content can only be read from the media and played by a respective device compatible with the media. Thus, when the user acquires the CD or DVD, the content could, conceivably, be several years in the making and be outdated.

Therefore, there is a need for a system and method which allows users to record content to a collectable format and to protect all licensing requirements of relevant industries. There is a further need for a system and method for converging traditional manufacturing and distribution of collectable content for digital data technologies such as the Internet.

### SUMMARY OF THE INVENTION

The present system and method provides a user with an ability to obtain collectable digital media post-purchase of a media disk. The user is authorized to download and save the new collectable digital media due to storage media licensing data (SMLD) stored on the media disk. The SMLD may include a pre-license obtained at the time of purchase or, alternatively, the ability to negotiate terms for rights to the collectable digital media. Thus, the present system and method allow users to record content to a collectable format, while protecting all licensing requirements of relevant industries.

Advantageously, the present system and method combines traditional manufacturing of digital media with distribution of collectable content for digital data technologies such as the Internet. In one embodiment, a master host disk (MHD) is purchased by a user. At the time of purchase, the MHD contains read only data such as videos and/or audio tracks (e.g., a movie on a DVD or songs on a CD). The MHD may also contain extra multimedia content such as electronic press kits, value-added visual items, screensavers, a video corresponding to a first “single release”, etc. However, not all content may be available at the initial time of purchase. For instance, a second and third video corresponding to a second “single release” and a third “single release” is typically not available.

The present system and method would allow the user to download and store onto the same MHD future collectable content such as the second and third “single release” video, as the content becomes available. The licensing rights in the SMLD stored on the MHD will be authenticated by a rights management server somewhere on the Internet. If the rights management server determines that the user has rights to the new content, then the user is allowed to access and download the new content from a content server.

The present invention may be utilized in various industries such as music, film, and television and may be embodied on various media such as DVD storage media, CD storage media, and hybrid optical disk media. Further, the present invention may be in practice on hard disks or other storage media formats. Other advantages, features, and embodiments of the present invention will be apparent from the drawings and detailed description as set forth below.

### BRIEF DESCRIPTION OF THE DRAWINGS

FIG. 1 is a block diagram of a conventional enhanced CD structure;

FIG. 2 is a block diagram of a conventional DVD structure;

FIG. 3 is a block diagram of an enhanced CD-SM structure, according to the present invention;

FIG. 4 is a block diagram of a DVD-SM structure, according to the present invention;

FIG. 5 is a physical layout of an exemplary master host disk, according to the present invention;

FIG. 6 is an exemplary environment where the present invention may be practiced;

FIG. 7 is a detailed block diagram of an exemplary master host disk operating on a computing device;

FIG. 8 is an exemplary block diagram of an alternative master host disk;

FIG. 9 is a side view of a hybrid optical disk media, according to the present invention;

FIG. 10 is a top sectional view of a hybrid disk media with P channel sub-code data;

FIG. 11 is a top sectional view of an alternative optical disk, according to the present invention; and

FIG. 12 is a flowchart illustrating an exemplary method for using SMLD disks.

### DETAILED DESCRIPTION OF EXEMPLARY EMBODIMENTS

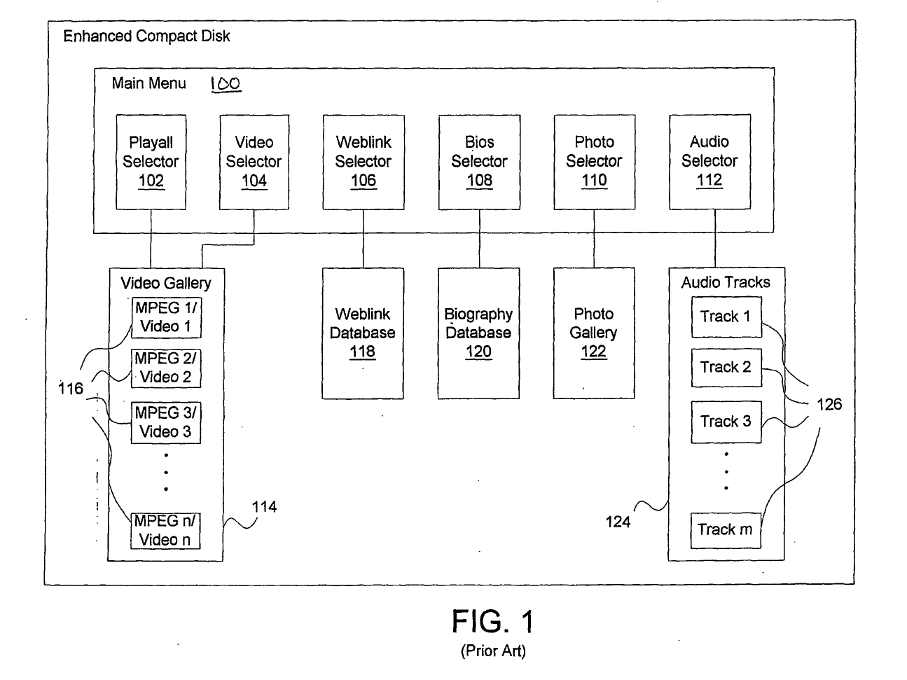

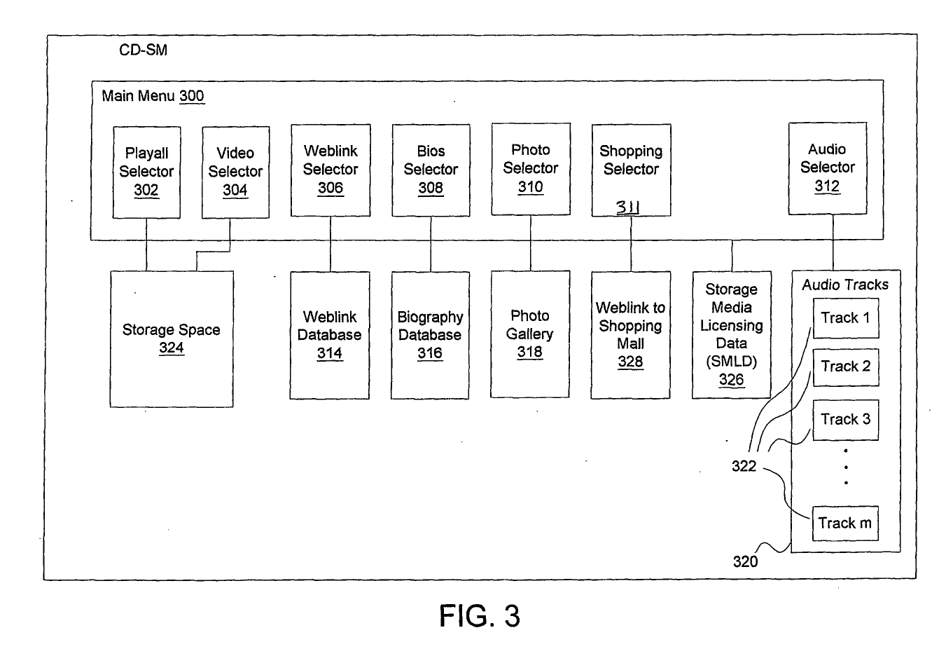

The present system and method overcomes or substantially alleviates present limitations associated with collectable digital media. Referring to FIG. 3, an exemplary embodiment of an enhanced CD according to the present invention is shown. The enhanced CD of FIG. 3 is similar to the conventional E-CD of FIG. 1, and contains a main menu section 300 which further comprises a play all selector 302, video selector 304, a web link selector 306, a biography selector 308, a photo selector 310, and an audio selector 312. Similarly, the enhanced CD further comprises a web link database 314 containing web addresses, a biography database 316 containing artist biographical information, and a photo gallery 318 which supplies photos. Finally, the enhanced CD contains an audio track database 320 containing a plurality of audio tracks 322.

However, unlike the conventional E-CD of FIG. 1, the enhanced CD of FIG. 3 contains a storage space 324 that is a license storage area for containing further content. Authorization for storing of content onto the storage space 324 is contained in a storage media licensing data (SMLD) area 326. The SMLD contains rights for the users to populate the storage space 324 with predetermined licensed content or user selectable content of choice as defined by the SMLD 326 terms and conditions. Preferably, the additional content is downloaded from a website identified in the web link database 314. As part of the SMLD process, the video selector 304 is updated with reference to content that is recorded in the storage space 324. Because the embodiment of FIG. 3 allows for post-manufacturing storage media (SM) processing, the enhanced CD is preferably known as an enhanced CD-SM.

FIG. 3 further illustrates an optional shopping selector 311 which accesses a dedicated web link to a shopping mall 328. For example, the user of the E-CD may want to purchase a t-shirt from the artist on the E-CD. The shopping mall link 328 would connect the user directly to a website providing items related to the particular artist.

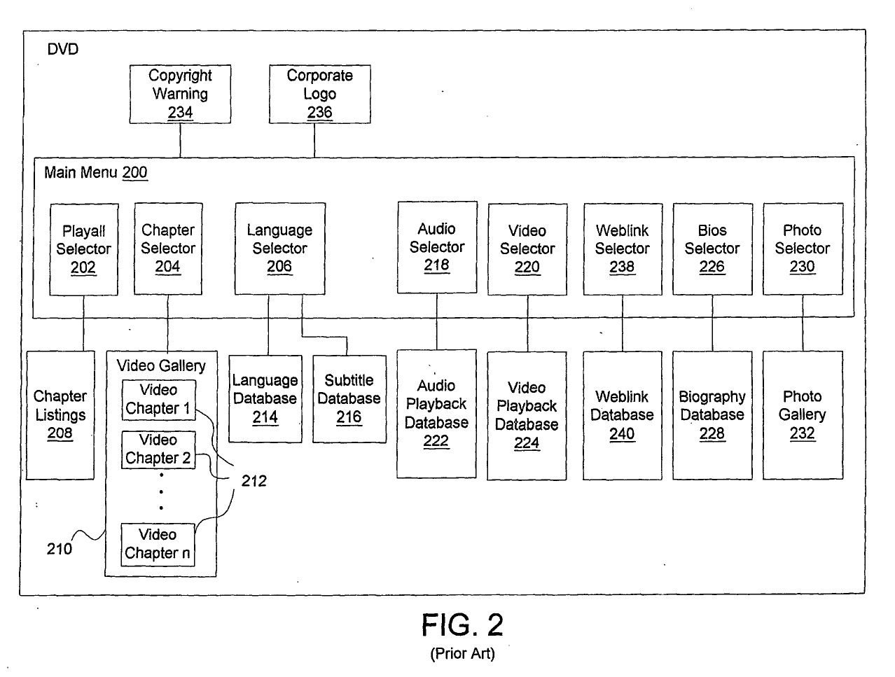

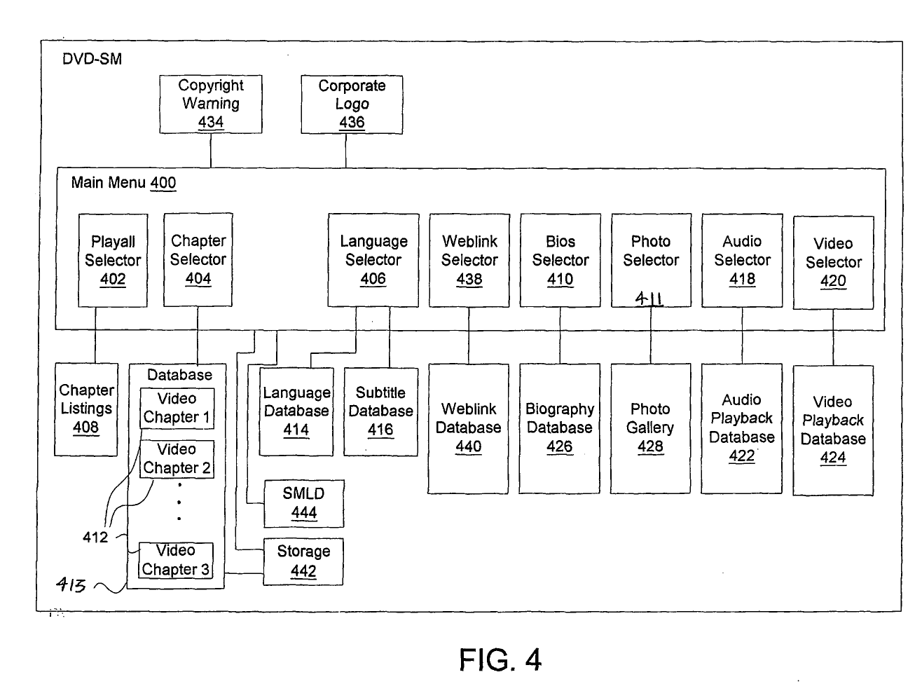

Referring now to FIG. 4, an exemplary block diagram of a DVD capable of post-manufacturing content storage (e.g., DVD storage media) is illustrated. The DVD storage media (DVD-SM) is similar to the conventional DVD of FIG. 2 containing a main menu section 400, which further comprises a playall selector 402 (e.g., play the entire movie), a chapter selector 404, and a language selector 406, all of which adjust viewing qualities of a movie contained on the DVD. These selectors are preferably coupled to their respective databases: the playall selector 402 is coupled to a chapter listing 408, the chapter selector 404 is coupled to a video database 413 containing video chapters 412, and the language selector 406 is preferably coupled to both a language database 414 and a subtitle database 416. Although FIG. 4 shows selection of subtitles through the language selector 406, alternatively, a separate subtitle selector may be utilized in the main menu selection 400.

Similarly, playback of the movie may be tailored to a users preference by an audio playback selector 418, which sets sound options for the movie such as “stereo 5.1”, and a video playback selector 420, which sets video display options such as normal or widescreen display. The audio options are preferably stored in an audio playback database 422, while the display options are stored in a display playback database 424.

As with the conventional DVDs, the DVD-SM may contain additional multimedia content such as artist biographies and photos. Therefore, the DVD-SM may optionally comprise an artist biography selector 410 coupled to a biography database 426 and a photo selector 411 coupled to a photo gallery 428. Other optional extra content can be embodied on the DVD-SM. Preferably, the DVD-SM further comprises a copyright protection message 434 and a corporate logo 436. Further, a web link selector 438 may be provided for enabling a connection to a website listed in a web link database 440.

In this exemplary embodiment of the present invention, the read/writable DVD-SM, a form of a read/writable DVD, further contains a storage area 442 and storage media licensing data (SMLD) 444 area which allows for collecting and storing additional content in the storage area 442. This content can include, for example, a season of a sitcom, a series of races, or other sporting collections. The SMLD 444 allows for more content to be stored in the storage space 442, typically post-purchase of the DVD, under a permission set as described by the SMLD 444. This additional content is preferably indexed though the chapter selector 404, which forms a table of contents.

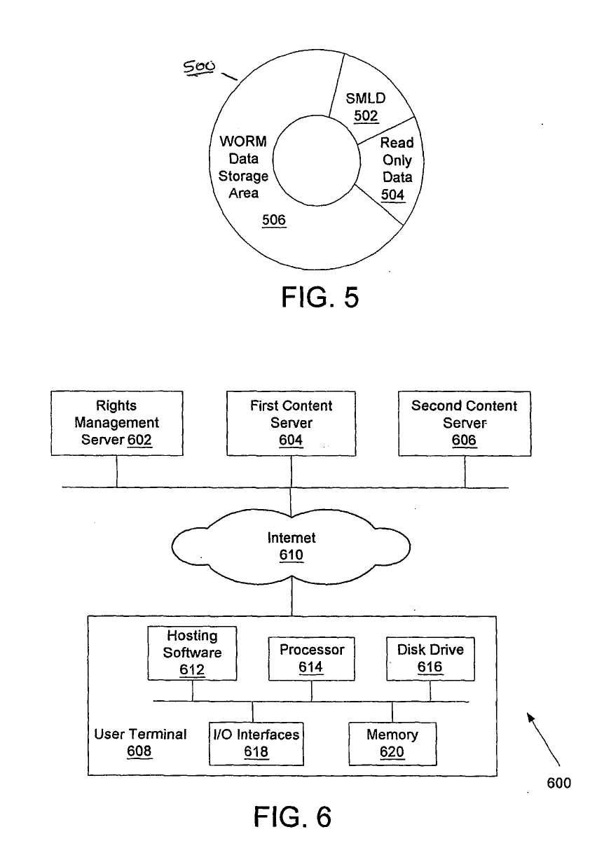

FIG. 5 illustrates a physical layout of an exemplary master host disk (MHD) 500, which is originally sold to a consumer. A MHD may be a CD-SM, a DVD-SM, or other similar recordable media. In the embodiment shown in FIG. 5, the MHD 500 is a CD-SM. The MHD 500 is shown comprising a SMLD data area 502, a Read Only Data area 504, and a Write Once Read Many (WORM) data storage area 506. The SMLD data area 502 is write protected, and may be located in a closed sector of the master host disk 500. Rights contained in the SMLD data area 502 permit recording of further content that is available either historically or in the future as content becomes available. The WORM data storage area 506 is initially unpopulated. Subsequently, a user populates the WORM data storage area 506 with collectable content as permitted by the SMLD 502. This process will be described in more detail below.

Referring now to FIG. 6, an exemplary environment 600 utilizing the MHD 500 of FIG. 5 is illustrated. The exemplary environment 600 preferably includes a rights management server 602, a first content server 604, a second content server 606, and a user terminal 608 all coupled to Internet 610. Although a first and a second content server 604 and 606 are shown, alternatively, any number of content servers may be coupled to the Internet 610 to provide collectable content to a user. In a further embodiment, the rights management server 602 and the first or second content server 604 or 606 may be the same server or located in the same location.

The user terminal 608 further comprises hosting software 612 and typically computing devices such as a processor 614, a disk drive 616, I/O interfaces 618, and memory 620. The disk drive 616 allows for access to data from and writes collectable content to the MHD 500, particularly if the memory 620 is not sufficiently large or if local caching is required, while the I/O interfaces may include video output, audio output, and data input and output. Preferably, the user terminal 608 is coupled to the Internet 610 through a broadband connection. Alternatively, other types of connections may be utilized.

According to the embodiment of FIG. 6, when new content is released or when the user desires to store new content of his choosing, the user terminal 608 negotiates with the rights management server 602 using the content of the SMLD 502 (FIG. 5) of the MHD 500. Assuming the SMLD 502 contains license rights to the new content, the rights management server 602 will allow access to the new content.

Alternatively, the SMLD 502 may negotiate terms of a new license agreement for the desired content. Subsequently, the new content may be downloaded from one or more content servers 604 and 606. To achieve this functionality, the user terminal 608 preferably incorporates and uses the hosting software 612.

For example, a recording artist may release a MHD 500 containing audio tracks 320 (FIG. 3), web links, artist biography information, and photo images, which form a core body of recording work by the artist along with their first video clip for their first “single release”. The MHD 500 can further include an electronic press kit (EPK) that informs the users about facts behind the body of work, and hyperlinks to shopping malls or Artist Websites.

Typically, video clips for a second, third, fourth, and subsequent “single release” from a recording artist's MHD 500 album has not been created at the time of the release of the MHD 500. In fact, it is unlikely that the order of the second, third, fourth, and subsequent “single release” has been determined at the time of the MHD 500 release. Thus when the second single is released, the user terminal 608 notifies the user of the availability of a video clip for the second “single release”. Because the MHD 500 contains a license in the SMLD 502 which allows for the recording of the second video clip, the second video clip can then be downloaded from one of the content servers 604 or 606 and recorded onto the WORM storage area 506 (FIG. 5) of the MHD 500. Similarly, video clips corresponding to the third, fourth, and subsequent releases may be recorded as the video clips become available.

Alternatively if the SMLD does not authorize the user to download the new content, the SMLD may negotiate terms of a new license which will permit the user to download the content. For example, the user may desire to download a music video corresponding to an audio track on the MHD 500, but does not currently have license to do so. Through negotiations, the user will agree to pay a license fee for the content.

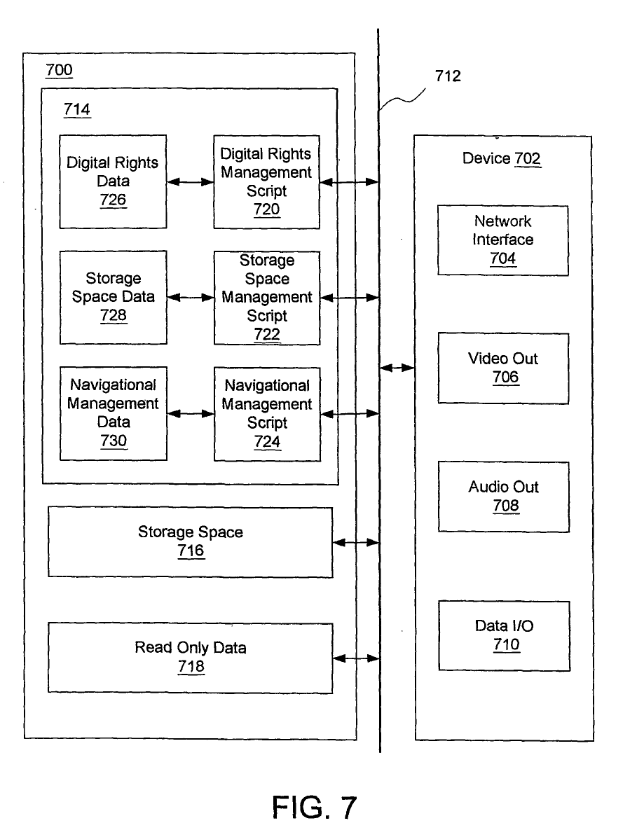

The following describes in more detail operations of the storage media licensing data (SMLD) management system. Referring now to FIG. 7, an exemplary block diagram of an MHD 700 operating on a computing device 702 is shown. The computing device 702 may be similar to the user terminal 608 of FIG. 6, and may comprise a network interface 704 which forms a bi-directional link with the Internet 610 (FIG. 6), a video out port 706, an audio out port 708, and a data input/output port 710. Preferably the video out port 706 is coupled to a display for viewing of video content, while the audio out port 708 is coupled to at least one speaker. Digital data may be shared between the computing device 702 and the MHD 700 via a bus 712. For example, the computing device 702 accesses a Read Only Data area 718 via the bus 712 of the MHD 700 when a ‘play’ operation is activated either automatically or manually.

Preferably, the MHD 700 comprises storage media licensing data (SMLD) 714, storage space 716, and the Read Only Data area 718. The SMLD 714 further comprises three script areas and three data areas. The script areas include a digital rights management script 720, a storage space management script 722, and a navigational management script 724, while the data areas include digital rights data 726 coupled to the digital rights management script 720, storage space data 728 coupled to the storage space management script 722, and navigational management data 730 coupled to the navigational management script 724.

Upon user acknowledgement or other automated initiation, the computing device 702 reads the digital rights management script 720 and executes a code contained within the digital rights management script 720. The code in the digital rights management script 720 causes the computing device 702 to access the digital rights data 726. Subsequently, the digital rights data 726 is sent to the rights management server 602 (FIG. 6) via the network interface 704. If the digital rights data 726 is acceptable to the rights management server 602, then the rights management server 602 acknowledges the computing device 702. Next, the computing device 702 initiates a read of the storage space management script 722 and executes a code contained within the storage space management script 722. This code causes the computing device 702 to read the storage space data 728 to determine where in the storage space 716 to write new content. Preferably, the storage space management script 722 also contains bit budgeting management whereby storage space 716 is checked against incoming content data size and ensured data integrity.

Finally during playback of the MHD 700, the computing device 702 accesses the navigational management script 724 in order to execute a code contained in the navigational management script 724. Consequently, the navigational management script 724 causes the computing device 702 to read the navigational management data 730, and process the navigational management data 730 according to the navigational management script 724 to create menus from which the user can co-access the new content along with the pre-existing read only content.

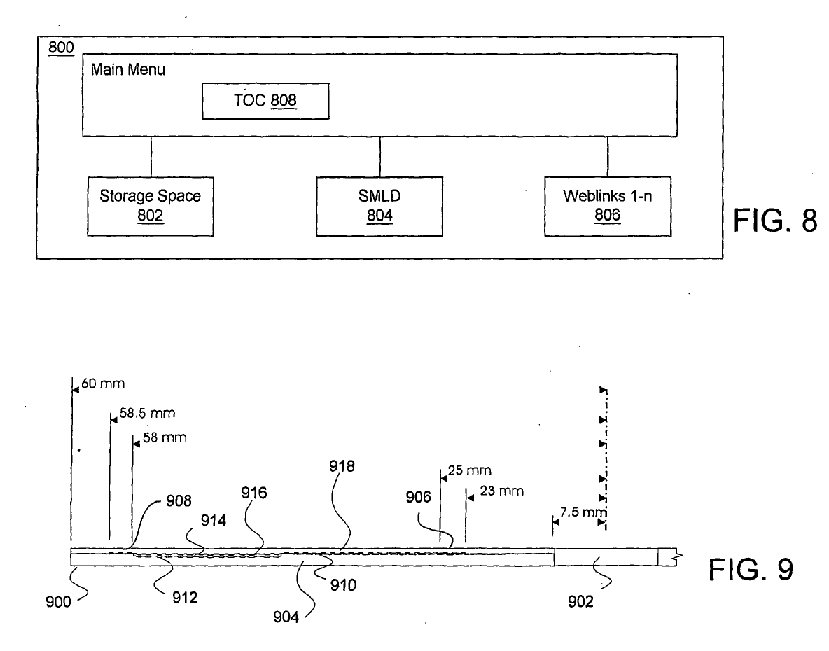

In an alternative embodiment, the SMLD may be used to archive data whereby licensing rights are built into the storage medium. FIG. 8 shows an exemplary block diagram of an MHD 800 where the MHD 800 is a compact disk-recordable storage media (CD-R-SM). Typically, the MHD 800 is used to backup data or copy and distribute licensed software applications or other content. Preferably, the MHD 800 contains a storage space 802, an SMLD 804, and web links 806. As a user attempts to record programs or applications, the SMLD 804 directs the user via web links 806 to an Internet site. At the Internet site, the user is able to transact a copyright to the content or application. Upon settlement of the copyright terms, the SMLD 804 allows a computing device to record the content or application onto the MHD 800. Data stored on the MHD 800 may be indexed using a table of contents (TOC) 808.

In one embodiment of the present invention, a MHD purchase fee includes a license fee that is interpreted by the SMLD. Thus, the user purchases a pre-license for additional content at the time the user purchases the original MHD. For example, the user may purchase a Microsoft application archive disk. The user can then burn a copy of a specific Microsoft application from a digital master or source since the user has pre-licensed the rights to make the copy. Alternatively, the SMLD media may be any random access digital storage technology that constitutes a collectable item.

In another embodiment, the SMLD technology may be used in optical disk media. FIG. 9 shows a side section view of a hybrid optical disk medium 900. In the present exemplary embodiment, the medium 900 is an SMLD CD audio disk medium. The medium 900 has a center hole 902, preferably, with a radius of 7.5 mm and a polycarbonate substrate 904 with an outer diameter of 120 mm, as is the standard for the most popular optical disk size. Alternatively, the medium 900 may comprise center holes 902 and outer diameters of other sizes and other forms of substrates. The medium 900 further contains a lead in area 906 with a radius of 23 mm to 25 mm and a lead out area 908 with a radius of 58 mm to 58.5 mm as per the Red Book standard for CD technology. An inner portion of the medium 900 contains read only data 910. The lead out area 908 also contains read only data at a 2 Hz requirement.

Manufacture of the hybrid optical disk medium 900 is suitable for mass production. Initially, the polycarbonate substrate 904 is molded using conventional optical disk read only mass production techniques. However, the mold has a modified area, a groove area 912, which contains a WORM technology groove. In the next stage of production, the WORM groove area 912 is covered with an organic dye or other write once recordable medium leaving a dye layer 914 on the polycarbonate substrate 904 above the groove area 912. Spin coating or other mass production techniques can apply the dye layer 914. Next, the polycarbonate substrate 904 and dye layer 914 are then covered with a reflective layer 916 using sputtering techniques. A final protective layer 918 is then applied on top of the reflective layer 916.

Advantageously, the hybrid optical disk medium's dye layer 914 does not readily attach itself to the sputtered reflective layer 916. Further, unlike a typical CD-R disk which obtains rigidity from the outer and inner edge and has a dye layer covering the entire data area, the dye layer area 914 of the hybrid medium is reduced and supported on either side by stronger adherence in the reflective layer 916 to the polycarbonate substrate 904 in the inner read only area 910. Thus, the hybrid medium 900 is physically stronger and more reliable than the standard CD-R format. It should be noted that the present invention is not limited to adherence to a singular write area or a singular read only area.

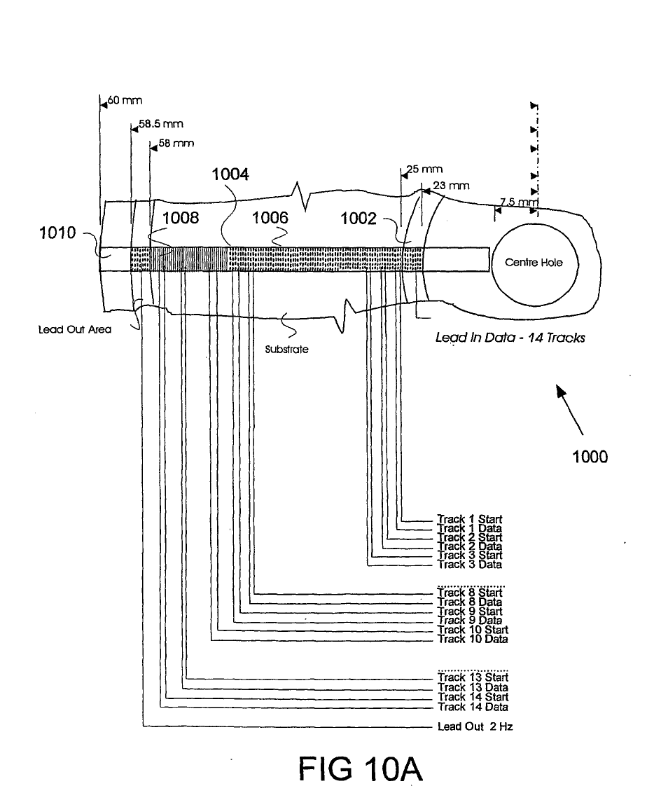

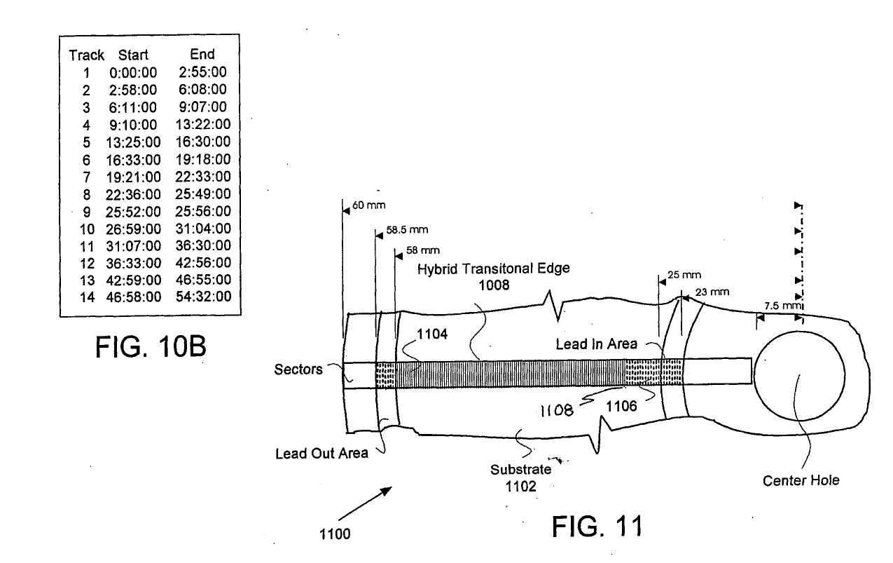

However, the hybrid optical disk medium 900 will require data management to ensure the medium 900 is compatible with existing technology. Referring now to FIG. 10A, a top sectional view of an exemplary embodiment of a SMLD hybrid writable optical disk 1000 similar to the embodiment of FIG. 9 is shown. However, the embodiment of FIG. 10A further includes P channel sub-code data as described in IEC908 Red Book CD standards, which is used to pre-define track start points on the CD Audio section of the hybrid optical disk 1000.

The hybrid optical disk 1000 contains a lead in area 1002 containing read only data that is used to state the number of tracks on the optical disk 1000, start points of the tracks, and duration of the tracks. In the exemplary embodiment, 14 tracks are located on the disk 1000. The start and durations of these 14 tracks are described in a table of FIG. 10B. A read only data section 1006 on the disk 1000 contains start and track data for tracks 1 through 8. Preferably, track 9 is used as a dummy track to manage transition of an optical media (and optical disk reading and writing) laser past a hybrid writable transitional edge 1004. The hybrid writable transitional edge 1004 is the location where a read only pit area 1006 on the disk 1000 changes to a WORM groove area 1008 on the disk 1000.

By manipulating the P channel data for track 9, an absolute start point can be set on the read only pit area 1006 of the optical disk 1000. The duration of track 9 is preferably set to four seconds (i.e., the minimum duration under the Red Book standards), and the start area for track 10 is preferably set for one minute later. Thus, an absolute start point of track 10 is set in the WORM area 1008 of the disk 1000, as are absolute start points of tracks 11 through 14.

When using a read-only laser, the disk 1000 appears to be a typical 14-track CD audio product as described by the lead in data. Further, lead in points on tracks 10 through 14 and associated data, initially, do not exist on the disk 1000. Thus, when the read laser goes to the area on the disk 1000 containing tracks 10 through 14, the read-only laser will report that no data is present and skip the tracks. Track 9 is set to four seconds in duration and will also be skipped by a read-only logic of the laser.

However, during a recording stage, a write laser is directed to the start point of tracks 10 through 14, and writes data as CD audio for CD-recordables. It should be noted that duration and tracks 10 through 14 are determined at the time of manufacture of the original read only product.

Disadvantageously, updated content duration of the hybrid CD audio application of SMLD as previously described is limited by pre-production information contained in the P channel track data 1010 on the read only area. However, the Universal Disk Format for DVD-ROM alleviates requirements for any pre-production definitions of writable storage area of the SMLD. Referring now to FIG. 11, a top sectional view of an exemplary optical disk 1100 data structure is shown. Preferably, the exemplary embodiment of FIG. 11 is a Universal Disk Format IS09660 level 3 compliant optical disk structure. This disk structure can be used to create a SMLD for CD-ROM or DVD-ROM. Under this disk structure, the DVD-ROM may contain DVD audio and/or DVD video files.

The disk 1100 containing an optical disk substrate 1102 is predominantly populated with a writable groove area 1104. A read only data area 1106 is a small area located on an inside portion of the disk 1100. The read only data area 1106, written in sector format, contains storage media licensing data (SMLD) and other content including content under the Universal Disk Format standard as well as an initial table of content that relates sector logical locations to file locations as defined by standard operating systems. The read only data area 1106 contains a closed session, which contains an address of the start sector of a new session. This sector is chosen to lie well inside the groove area 1104 such that the sector passes a hybrid transitional edge 1108 where coverage of organic dye material or other write once recordable medium is not controlled precisely by the manufacturing process.

Although reference is made to writable groove technology, any writable or rewritable technology existing or to be invented can be used in substitution for the groove area referred to in the above described embodiments.

IS09660 level 3 allows for use of packet writing of data onto CD-R and DVD+RW or other DVD formats. Initial read only data may be in a packet written format. Packet writing data format benefits SMLD technology as the format allows for a table of contents to be passed over from a pre-updated disk to a post-updated disk, session by session. Packet writing also allows for variable update file lengths that do not have to be determined by any pre-production process.

Content can be added to the disk 1100 and the updated table of contents file can be written upon session closure each time the disk 1100 is updated. Beneficially, the read only data can contain the initial table of contents. Under the IS09660 level 3 standard when the disk 1100 is closed, the disk 1100 is readable by an IS09660 level 1 reader. Before closure, a software drive in an operating system can be used to create a virtual file allocation table (VFAT) for file logical locations from the sector data or packet data of the disk media. Thus, the media is readable in a DVD burner. The only restriction is to ensure the disk 1100 is not fully written before a final session is closed and an IS09660 level 1 table of content can be written. After the session is closed and the updated contents has been burnt to the SMLD, the disk 1100 becomes readable by level 1 readers or standard DVD players.

In a further embodiment a measure is made of the remaining burnable storage space left in the storage area to ensure new content will not cause the disk to be fully written before the a final session is closed.

Although the present embodiment references IS09660, the standard by which the SMLD is implemented can be any other existing or to be defined standard applicable to optical disk media.

Further, a DVD-ROM can be organized such that as new video files are added, the files are included in a VIDEO_TS directory. The table of contents and other files are updated to notify the DVD player of the presence of the new content. Similarly, hybrid DVD formats and variations of CD formats can be manufactured and managed for SMLD compatibility as described herein.

In a further embodiment, the SMLD may contain an encryption key that forms part of a decryption of a file before, or as a file is written to the storage media. In yet another embodiment, the SMLD can contain a remote login username, password, and script that automatically takes the user to a private secure web site.

Alternatively in another embodiment, a blank unformatted or pre-formatted optical disk such as a DVD+RW may have a table of content and files written by an end-user to be made into an SMLD. In this embodiment, a blank disk is placed in a burner or recorder. The user then applies various options through a software interface as to what content the user desires to record. The table of contents and files are generated by a software application, which burns or records equivalent SMLD data onto the blank disk. The process may include a transaction for cost of a license or service. Alternatively, the license fee may be zero and the SMLD is used as a service only. For example, a software application may be used over the Internet to program a series of television shows that a user wants to record. A menu driven selection process on an Internet site then compiles appropriate files and downloads the files to the user's computing device, which in turn creates an SMLD from a blank disk. Effectively, this process solves problems related to programming a video recorder, or in this present embodiment, the DVD recorder, by taking full effect of digital capacity of the DVD media and SMLD technology. The software application used for selecting recording parameters may reside only in the host device and therefore this embodiment may function without Internet connectivity.

In a further embodiment a SMLD hybrid blank disk is used containing the software application in the read only area of the hybrid disk.

In another example, rights are purchased over an Internet-based application to record a series of content such as a sitcom. Generated SMLD data are downloaded over the Internet and burned to a blank disk. The blank disk is inserted into the DVD recorder and programs the recorder accordingly. As the sitcom is broadcasted, the DVD recorder starts recording and stops recording on cue. The SMLD data may include an ability to download a show at a later time should the disk not be present in the DVD recorder during the show's actual broadcast.

In an alternative embodiment a blank recordable or re-writable disk is burnt with SMLD data and the disk is inserted into a DVD Recorder. The SMLD data is used to program the DVD Recorder to record an analogue content sourced from cable or free to air transmissions. The benefit of this embodiment is that digitally encoding the new content occurs at the DVD Recorder thus avoiding the need to have a broadband Internet connection or wide area network infrastructure at the users premises.

In a further embodiment, the MHD may be a DVD Plus-SM format. In this embodiment, the user is able to purchase a DVD Plus album (e.g., a format containing DVD on one side and enhanced CD on the second side) of an artist. Audio tracks are stored on the enhanced CD side of the MHD. The DVD side may contain an electronic press kit, a first video, and other video content. Subsequently, the user is able to download via the Internet, new videos when a next single is released. The cost of the download for each video may be that of a normal single audio release. Thus, the user is capable of continually adding on to his or her album. Shelf life of the album is then extended, and music companies and artists are able to enjoy an ongoing revenue stream.

In another example of this embodiment, suppose the MHD is applied to televised sports, for example auto racing. A user may purchase a disk just released to cover a full Grand Prix season. The disk may feature a summary of last season, an overview of each team, and structure and details of all cars this season. The user then downloads each race weekly. At the conclusion of the season, the user holds the complete season of racing with easy access menus for quick reference. Should the original read only content and the additional updated content be greater than the storage space provided by one hybrid optical disk then a plurality of hybrid optical disks may constitute a complete set of the collectable item.

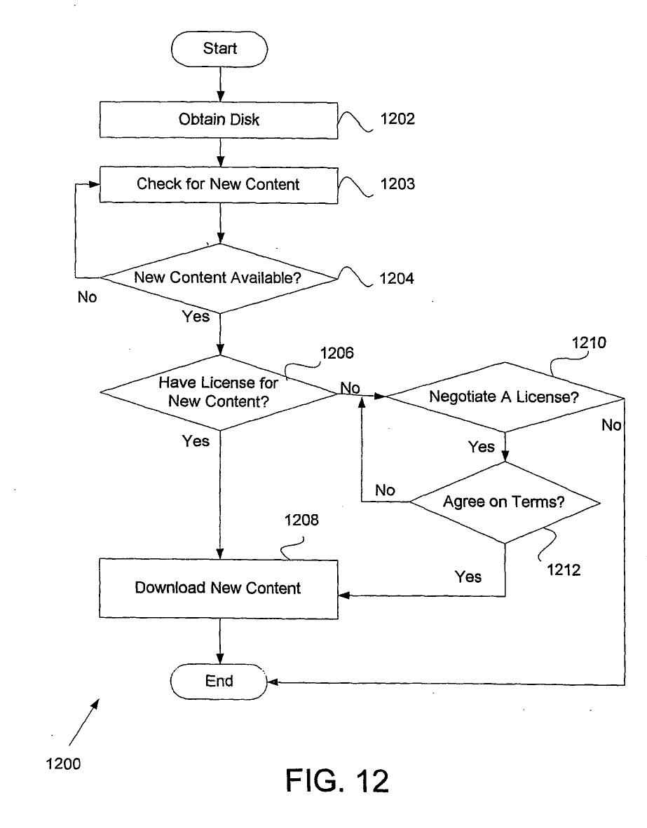

FIG. 12 is a flowchart 1200 illustrating an exemplary method for using an MHD. For illustration purposes the method will be described with reference to the DVD-SM of FIG. 4. In block 1202, a user obtains the MHD. As previously described, the MHD can be any type of recordable media including DVD-SM, CD-SM, and hybrid optical disk media. Typically, the user will purchase the MHD from a retailer. Preferably, the MHD will contain historical content such as video chapters 412 (FIG. 4), language and subtitle data, and audio and video playback options. The MHD also will contain an SMLD 444 (FIG. 4).

Next in block 1203, the user checks for new content available for the MHD. The check may be automatic or manual. For example, the MHD may automatically connect via the Internet to a designated website, as provided in the web link database 440 each time the MHD is used. Alternatively, the MHD may be programmed to check at certain intervals in time or on certain dates.

If new content is available in block 1204, the MHD will send storage media licensing data 444 (FIG. 4) to the rights management server 602 (FIG. 6) for authentication. If the rights contained in the SMLD 444 authorizes the user to access the new content, then the user is allowed to download the new content to the storage space 442 (FIG. 4) of the MHD. Alternatively, if the user does not have rights to the new content, then the user may have the option of negotiating rights to the data in block 1210. Terms of the negotiation include the amount of new content the user is interested in and a license fee that the user will agree to pay. Once agreeable terms are reached in block 1212, then the user is allowed to access and download the new content to storage space 442 in block 1208.

Although reference is made throughout this detailed description to optical disk media, the SMLD method can be applied to any other digital storage media currently existing or to be invented.

Although reference is made throughout this detailed description to SMLD residing on an optical disk media, the SMLD data may alternatively be stored in volatile or non-volatile memory of the host device.

The invention has been described with reference to specific embodiments. It will be apparent to those skilled in the art that various modifications may be made and other embodiments can be used without departing from the broader scope of the invention. For example, alternative forms of disk media may be used in the present invention. Therefore, these and other variations upon the specific embodiments are covered by the present invention.

What is claimed is:

1. An updatable storage medium comprising:
storage media licensing data for authorized storage of new content; and
and a storage area for storing the new content onto the storage medium.

2. The updatable storage medium of claim 1 further comprising a read only data area.

3. The updatable storage medium of claim 2 wherein the read only data area further comprises audio tracks.

4. The updatable storage medium of claim 2 wherein the read only data area further comprises video content.

5. The updatable storage medium of claim 2 wherein the read only data area further comprises data content.

6. The updatable storage medium of claim 1, wherein the storage media licensing data is a pre-license for access to the new content.

7. The updatable storage medium of claim 1, wherein the storage media licensing data negotiates with a rights management server for access to the new content.

8. The updatable storage medium of claim 1 further comprising a web link database containing at least one web link, the web link connecting the updatable storage medium to a content server for access to the new content.

9. The updatable storage medium of claim 1, wherein the storage medium licensing data further comprises automated instructions for programming a user interface of a host device.

10. The updatable storage medium of claim 1, wherein the new content is encrypted.

11. The updatable storage medium of claim 10, wherein the new content is decrypted by a key obtained by a key server.

12. The updatable storage medium of claim 10, wherein the new content is decrypted by a key obtained from a storage media read only data area.

13. An updateble storage medium comprising:
storage media licensing data for obtaining authorized access to new content;
and a storage area for storing the new content onto the storage medium.

14. The updatable storage medium of claim 13 further comprising a read only data area.

15. The updatable storage medium of claim 14 wherein the read only data area further comprises audio tracks.

16. The updatable storage medium of claim 14 wherein the read only data area further comprises video content.

17. The updatable storage medium of claim 14 wherein the read only data area further comprises data content.

18. The updatable storage medium of claim 13, wherein the storage media licensing data is a pre-license for access to the new content.

19. The updatable storage medium of claim 13, wherein the storage media licensing data negotiates with a rights management server for access to the new content.

20. The updatable storage medium of claim 13 further comprising a web link database containing at least one web link, the web link connecting the updatable storage medium to a content server for access to the new content.

21. The updatable storage medium of claim 13, wherein the storage medium licensing data further comprises automated instructions for programming a user interface of a host device.

22. The updatable storage medium of claim 13, wherein the new content is encrypted.

23. The updatable storage medium of claim 22, wherein the new content is decrypted by a key obtained by a key server.

24. The updatable storage medium of claim 22, wherein the new content is decrypted by a key obtained from a read only data area of the storage medium.

25. A system for updating recordable storage media with new content comprising:
a recordable storage medium having storage media licensing data;
a rights management server for determining whether the storage media licensing data authorizes access to the new content; and
at least one content server for providing the new content to the storage medium.

26. The system of claim 25 wherein the rights management server and the at least one content server are both located within one device.

27. The system of claim 25 further comprising a user terminal in which the recordable storage medium operates.

28. The system of claim 27 wherein the user terminal further comprises a network interface for coupling the recordable storage medium to the rights management server and the at least one content server.

29. The system of claim 25 wherein the recordable storage medium is a CD-SM.

30. The system of claim 25 wherein the recordable storage medium is a DVD-SM.

31. The system of claim 25 wherein the recordable storage medium is a DVD Plus-SM.

32. An updatable storage medium with storage medium licensing data, the storage medium licensing data comprising:
a digital rights management script;
digital rights data coupled to the digital rights management script, the digital rights data being verified by a rights management server to determine authorization to access new content;
a storage space management script; and
storage space data coupled to the storage space management script, the storage space data providing storage location information for the new content.

33. The storage medium licensing data of claim 32, wherein the storage space management script further comprises bit budgeting management whereby storage space is checked against the new content data size to ensure data integrity.

34. The storage medium licensing data of claim 32 further comprising a navigational management script, the navigation management script causing a read of navigational management data which creates menus for co-accessing the new content along with read only content.

35. A method for licensing new content on updatable storage media comprising the steps of:
obtaining a storage medium having storage medium licensing data;
checking if new content is available for download and storage;
determining if a user is authorized to access the new content; and
if the user is authorized, downloading and storing the new content onto the storage medium.

36. The method of claim 35 wherein the step of checking occurs automatically each time the storage medium is used.

37. The method of claim 35 wherein the step of checking occurs at programmed intervals.

38. The method of claim 35 wherein the step of determining further comprises the step of sending the storage medium licensing data to a rights management server for comparison.

39. The method of claim 35 further comprising the step of negotiating rights to the new content if the user is not authorized.

40. The method of claim 35 wherein the step of downloading and storing further comprises the step of encrypting the new content.

41. The method of claim 40 further comprising the step of decrypting the new content with a key obtained from a key server.

42. The method of claim 40 further comprising the step of decrypting the new content with a key obtained from the a read only data area of the storage medium.

43. A system for licensing new content on updatable storage media comprising:
means for obtaining a storage medium having storage medium licensing data;
means for checking if new content is available for download and storage;
means for determining if a user is authorized to access the new content; and
if the user is authorized, means for downloading and storing the new content onto the storage medium.

44. The method of claim 43 wherein the step of downloading and storing further comprises the step of digitally encoding the new content, the new content being an analogue content sourced from cable or free to air transmissions.

45. A method for licensing new content on updatable storage media comprising:
obtaining a storage medium;
adding storage medium licensing data to the storage medium;
checking if new content is available for download and storage;
determining if a user is authorized to access the new content; and
if the user is authorized, downloading and storing the new content onto the storage medium.

46. The method of claim 45 wherein the step of determining further comprises the step of sending the storage medium licensing data to a rights management server for comparison.

47. The method of claim 45 further comprising the step of negotiating rights to the new content if the user is not authorized.

48. The method of claim 45 wherein the step of downloading and storing further comprises the step of digitally encoding the new content, the new content being an analogue content sourced from cable or free to air transmissions.

49. A method for licensing new content on updatable storage media comprising the steps of:
providing a storage medium having storage medium licensing data to a user;
providing new content for download and storage by the user;
determining if a user is authorized to access the new content; and
if the user is authorized, allowing downloading and storing of the new content onto the storage medium.

50. The method of claim 49 wherein the step of determining further comprises the step of receiving the storage medium licensing data in a rights management server.

51. The method of claim 49 further comprising the step of negotiating rights to the new content if the user is not authorized.

52. The method of claim 49 wherein the step of downloading and storing further comprises the step of digitally encoding the new content, the new content being an analogue content sourced from cable or free to air transmissions.

53. A system for licensing new content on updatable storage media comprising:
means for providing a storage medium having storage medium licensing data to a user;
means for providing new content for download and storage by the user;
means for determining if a user is authorized to access the new content; and
if the user is authorized, means for allowing downloading and storing of the new content onto the storage medium.

54. The method of claim 53 wherein the step of downloading and storing further comprises the step of digitally encoding the new content, the new content being an analogue content sourced from cable or free to air transmissions.

55. A method for licensing new content on updatable storage media comprising:
providing a storage medium to a user;
providing storage medium licensing data to the storage medium;
providing new content for download and storage by the user;
determining if the user is authorized to access the new content; and
if the user is authorized, allowing downloading and storing of the new content onto the storage medium.

56. The method of claim 55 wherein the step of downloading and storing further comprises the step of digitally encoding the new content, the new content being an analogue content sourced from cable or free to air transmissions.
